(19) United States
(12) Patent Application Publication
(10) Pub. No.: US 2008/0199053 A1
(43) Pub. Date: Aug. 21, 2008

(54) Method for consolidating various financial type cards into a single card and providing positive identification of an individual using such card

(76) Inventor: Tariq Zafar, Severn, MD (US)

Correspondence Address: JAMES RAY & ASSOCIATES, 2640 PITCAIRN ROAD, MONROEVILLE, PA, 15146, US

(21) Appl. No.: 12/070,085

(22) Filed: Feb. 15, 2008

Related U.S. Application Data
(60) Provisional application No. 60/890,053, filed on Feb. 15, 2007.

(51) Int. Cl. G06K 9/00; G06Q 40/00

(52) U.S. Cl. 382/115; 705/35

(57) ABSTRACT

A method for each of simplifying, protecting and verifying financial transactions comprising the steps of selecting a predetermined electronic device capable of receiving and transmitting data; storing within such device selected certain predetermined financial information unique to an individual; providing at least one of a fingerprint scanner and a photographic image detector; connecting the at least one of such fingerprint scanner and such photographic image identifier provided to the electronic device selected; electronically connecting such electronic device to at least one of a financial banking institution machine and a point of purchase card reading device; and verifying at least one such individual's fingerprint and photographic image prior to completing a transaction.

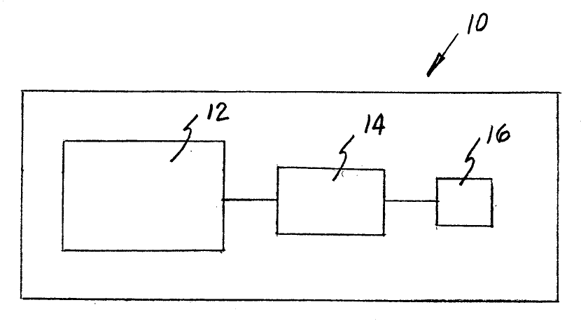

### CROSS REFERENCE TO RELATED APPLICATION

This patent application is related to and claims priority from U.S. Provisional Patent Application Ser. No. 60/890,053 filed Feb. 15, 2007.

### FIELD OF THE INVENTION

The present invention relates, in general, to cards used in financial transactions and, more particularly, this invention relates to a method and apparatus for consolidating various financial type cards into a single card to simplify financial transactions provide an improved way for verifying the individual using such apparatus.

### BACKGROUND OF THE INVENTION

Prior to the conception and development of the present invention, as is generally well known in the prior art, credit cards and debit cards are in with spread use throughout the world. Such credit cards may be issued by financial institutions which can be used in the majority of places or certain credit cards which can only be used at the issuing company. Examples of the former includes Visa, Mastercard, Discover, etc and examples of the latter includes Sears, J. C. Pennies and Home Depot.

These current credit card type systems have minimal built in security and usually are valid only for a single account. As a result, people normally carry a number of different credit cards on their person with each card good for each account they have.

This, as would be expected, significantly increase the possibility of financial damage to a person's credit rating if their wallet or purse having these numerous cards in them is either lost or stolen and such cards are used by unauthorized persons. Further when such cards are lost or stolen they must be reported to each issuing agency to have them cancelled and new cards issued. Obviously this is a time consuming hassle. Even worse, if the cards are not missed for some time and a re used during this time the person owing the card is responsible for the unauthorized use.

In order to reduce the risk some banking institutions or point of sale system utilize biometric verification which requires the storage of personal biometric data in a central repository.

### SUMMARY OF THE INVENTION

The present invention provides a method for each of simplifying, protecting and verifying financial transactions. Such method comprising the steps of selecting a predetermined electronic device capable of receiving and transmitting data. Storing within such device that is selected certain predetermined financial information unique to an individual. Further, the method includes providing at least one of a fingerprint scanner and a photographic image identifier and connecting such at least one of such fingerprint scanner and photographic image identifier provided to such device selected. Then electronically connecting the device to at least one of a financial banking machine and a point of purchase card reading device. Thereafter verifying at least one of such individual's fingerprint and photographic image prior to completing a transaction.

### OBJECTS OF THE INVENTION

It is, therefore, one of the primary objects of the present invention to provide a method for each of simplifying, protecting and verifying financial transactions which is more secure than presently used systems.

Another object of the present invention is to provide a method for each of simplifying, protecting and verifying financial transactions which is relatively easy to use.

Still another object of the present invention is to provide a method for each of simplifying, protecting and verifying financial transactions which can be used at a banking machine or a point of service (POS) device.

Yet another object of the present invention is to provide a method for each of simplifying, protecting and verifying financial transactions in which the system can be modified relatively easy.

An additional object of the present invention is to provide a method for each of simplifying, protecting and verifying financial transactions which can incorporate both fingerprint identification as well as photographic images.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

The sole FIGURE is a schematic illustration of a system for carrying out the presently preferred method.

### BRIEF DESCRIPTION OF A PRESENTLY PREFERRED AND VARIOUS ALTERNATIVE EMBODIMENTS OF THE INVENTION

Reference is now made, more particularly, to the sole FIGURE. Illustrated therein is a system, generally designated 10, for implementing a method for each of simplifying, protecting and verifying financial transactions.

The method includes the steps of selecting a predetermined electronic device 12 which is capable of both receiving and transmitting data. In the presently preferred embodiment of the invention such electronic device will be selected from a hand held PC device and a cell phone that is equipped with a USB port. Storing within the electronic device 12 that has been selected certain predetermined financial information unique to an individual. Such predetermined financial information that is unique to the individual will include at least one of credit card information, debit card information, and check card information.

Further, providing at least one of a fingerprint scanner 14 and a photographic image identifier 16. 4. In the presently preferred embodiment of the invention such method utilizes the fingerprint scanner. It is within the scope of the present invention for such method to provide fingerprints from both hands of such individual. It may also be the case where both fingerprint information as well as photographic identification of such individual may be required.

Thereafter, connecting such at least one of such fingerprint scanner 14 and photographic image identifier 16 provided to the electronic device 12 selected. When using the system, the method calls for electronically connecting such electronic device 12 to at least one of a financial banking machine (not shown) and a point of purchase card reading device (not shown). Thereafter, verifying at least one of the individual's fingerprint and photographic image prior to completing a transaction.

The method may further include the additional step of limiting a number of attempts to use the electronic device 12 to a predetermined number thereby ensuring if such electronic device 12 is lost or stolen it cannot be used. Preferably, such predetermined number is three and the method will include the additional step of erasing all personal information stored after three unauthorized tries.

It is further within the scope of the present invention for the method to include the capability of revising such stored information as desired by said individual. Additionally, such stored information is encrypted for each of privacy and security.

It can be seen from the above description that the present invention provides the system 10 is a combination of hardware and software that enables individuals to securely and easily manage their finances from USB-enabled computers including smart-phones, ATMs, and point of sale (POS) devices. This streamlined system 10 consolidates multiple financial accounts into a single electronic device 12 that is accessible through biometric verification without storing personal biometric information in a central repository.

Additional security is provided through encryption of all stored information, device serialization, and software protection. No personal data or programs are left on the computer, ATM, or POS used to perform the account activity. An authorized user can add, edit, and delete financial accounts and personal information or perform account transactions, but may not change the device programming.

The system 10 is designed to simplify financial transactions by consolidating credit cards, ATM cards, debit cards, check cards and other financial accounts into a single device that is capable of securely storing all account information and performing all necessary transactions. System offers additional security and portability by incorporation of fingerprint verification into a USB flash drive that can either be used at a USB-enabled bank kiosk, ATM for all banking transactions or from a personal computer or smart phone for secure transactions except deposits and cash withdrawals.

USB-enabled POS equipment would allow all secure credit, debit, or checking transactions. The system 10 stores financial account information as strongly encrypted data on a USB flash drive with a built-in fingerprint verification device 14. The electronic device 12 cannot be accessed and data cannot be decrypted and used without biometric (fingerprint) authentication, so if electronic device 12 is lost or stolen, biometric and personal financial data is not exposed.

Sequential authentication failures (number of tries selectable by user) lead to the personal data on the card being erased. Serialization of the system 10 adds further protection, such that cards reported lost or stolen can no longer be used and attempted use triggers a memory erasure. System 10 is capable of performing all financial transactions that are currently performed with multiple credit cards, debit cards and ATM/check cards, plus it allows for secure financial transactions over the Internet, including investment accounts.

Based on a USB flash drive with a fingerprint scanner, the system 10 includes special programming stored in a non-volatile memory that cannot be modified by the user. The programming does allow the user to store, edit, and delete information and to securely perform financial transactions. The system's 10 built-in fingerprint technology activates the card and provides the means to encrypt or decrypt any personal financial information stored on the card.

The initial biometric information is stored on the electronic device 12 at the time of activation. There is room in the memory for multiple prints from both hands and digital photographs of the person to whom the electronic device 12 was issued. The system 10 requires the user to provide fingerprint verification before the electronic device 12 can be used and any information on the card can be accessed or displayed. If for some reason the fingerprint verification fails, the user will be asked for a pre-stored password or three security questions before authorization is given to continue with any transactions.

At a bank kiosk or ATM, the user has all the transaction options that would be granted to traditional cardholders plus potentially new options that might be granted for positive identification provided by the system 10. With the present invention, all stored accounts in the electronic device 12 can be displayed, including credit cards, checking accounts and bills payable accounts such as mortgages, car loans and utility bills.

With this method, money can he transferred between accounts or bills can be paid securely. System 10 provides the option of establishing a default account for cash withdrawals and purchases. To use the system 10 for in-store purchases, the user would use the POS USE port, and the pre-established default credit, checking, or debit account will be used for the purchase unless the user chooses to use a different stored account that can be accessed through a pre-assigned account code. This also provides added security by not exposing the full account number outside the electronic transaction. Adding or deleting any accounts to the system 10 or making adjustments to the default accounts can be done at a bank kiosk, ATM or by any computer. System 10 programming also allows for encrypted back-up and restore of the electronic device 12 to another storage device using strong password protection.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A method for each of simplifying, protecting and verifying financial transactions, said method comprising the steps of:
(a) selecting a predetermined electronic device, said electronic device for each of receiving and transmitting preselected data;
(b) storing within said electronic device selected in step (a) certain predetermined financial information unique to an individual;
(c) providing at least one of a fingerprint scanner and a photographic image identifier;
(d) connecting said at least one of said fingerprint scanner and photographic image identifier provided in step (c) to said electronic device selected in step (a);
(e) electronically connecting said device to at least one of a financial banking institution machine and a point of purchase card reading device; and
(f) verifying at least one of said individual's fingerprint and photographic image prior to completing a transaction.

2. A method, according to claim 1, wherein said electronic device is selected from a PC and cell phones equipped with a USB port.

3. A method, according to claim 1, wherein said predetermined financial information unique to an individual includes at least one of credit card information, debit card information, and check card information.

4. A method, according to claim 1, wherein said method includes providing a fingerprint scanner in step (c).

5. A method, according to claim 4, wherein said method includes the step of providing fingerprints from both hands of said individual.

6. A method, according to claim 1, wherein said method further includes the step of providing photographic identification of said individual.

7. A method, according to claim 1, wherein said method includes the additional step of limiting a number of attempts to use the device to a predetermined number thereby ensuring if the device is lost or stolen it cannot be used.

8. A method, according to claim 7, wherein said predetermined number is three and said method includes the additional step of erasing all personal information stored after three unauthorized tries.

9. A method, according to claim 1, wherein said method includes the additional step of revising said stored information as desired by said individual.

10. A method, according to claim 1, wherein said stored information is encrypted for each of privacy and security.

11. A method, according to claim 1, wherein said method includes the additional step of eliminating all personal information at from said at least one of the financial banking institution machine and the point of purchase card reading device.
